(19) United States
(12) Patent Application Publication
(10) Pub. No.: US 2008/0277952 A1
(43) Pub. Date: Nov. 13, 2008

(54) TEXTILE SLING COMBINING MULTIPLE TYPES OF FIBERS AND METHOD OF MANUFACTURING SAME

(75) Inventors: Francois Inkel, Granby (CA); Sylvie Nerbonne, Granby (CA)

Correspondence Address: BERESKIN AND PARR, 40 KING STREET WEST, BOX 401, TORONTO, ON, M5H 3Y2, CA

(73) Assignee: PRODUITS BELT-TECH INC., Granby (CA)

(21) Appl. No.: 11/940,395

(22) Filed: Nov. 15, 2007

Related U.S. Application Data
(60) Provisional application No. 60/865,954, filed on Nov. 15, 2006.

(51) Int. Cl. B66C 1/12

(52) U.S. Cl. 294/74; 294/1.1

(57) ABSTRACT

A textile sling having a continuous weave pattern comprises, in the warp thread, a major weight content of a first type of yarn made of a first type of fibers and a minor weight content of a second type of yarn made of a second type of fibers. The second type of fibers has a higher Young's modulus than the first type of fibers. The second type of fibers has a higher Young's modulus than the first type of fibers. The second type of yarn has a longer free-length than the first type of yarn so that the second type of yarn does not rupture before the first type of yarn under a tension load. A method of manufacturing a textile sling comprises threading in the warp thread the first type of yarn made of the first type of fibers with the second type of yarn made of the second type of fibers. The second type of fibers has a higher Young's modulus than the first type of fibers. The second type of yarn is threaded with less tension than the first type of yarn.

### FIELD OF THE INVENTION

The present invention generally relates to the field of textile lifting slings. More specifically, the invention relates to a textile sling having a continuous weave pattern that combines, in the warp thread, a major weight content of a first type of yarn made of a first type of fibers with a minor weight content of a second type of yarn made of a second type of fibers having a higher Young's modulus than the first type of fibers.

### BACKGROUND OF THE INVENTION

For displacing heavy materials, it is common practice to use a crane or hoist whose downwardly-extending cable is provided with a hook, the hook being connected to the load by one or more flexible slings. A sling of this type usually consists of an elongated webbing having a soft eye at each end for engagement with the hook. The bight of the sling passes under the load and transfers the weight from the load to the hook.

Because of its low cost, polyester is often used in the manufacturing of these slings. However, polyester is a rather average performer when it comes to yield strength or wear resistance. Hence, it is customary to combine polyester with reinforcing fibers of another type to increase the overall physical properties of the sling. For instance, nylon fibers may be added on an edge of a polyester sling to increase its resistance to wear.

Such combination of fibers however, is not always possible. It all depends on the Young's modulus and the proportions of the fibers combined in the sling. Indeed, in the previous example, a major weight content of polyester yarns is combined with a minor weight content of nylon yarns, whose fibers have a lower Young's modulus than polyester fibers. Therefore, polyester fibers, making up the bulk of the sling, bear most of the load. This combination is known to provide adequate results.

The problem arise when trying to combine a major weight content of yarns made from a type of fibers that has a lower Young's modulus than that of a second type of fibers making up a minor weight content of a second type of yarns. Indeed, Hammersia, in U.S. Pat. No. 4,856,837, explains that using Kevlar™ reinforcing yarns, in the warp thread of a sling made primarily of polyester, causes the Kevlar™ reinforcing yarns to break prematurely. This is caused by the fact that the Kevlar™ yarns cannot elongate as much as the yarns made of polyester (polyester has a lower Young's modulus than aramid fibers, also known as Kevlar™) and therefore absorb the totality of the load in the first moments the sling is loaded. An alternative may be to exclusively use yarns made of fibers having a high Young's modulus. However, these fibers are typically much more expensive than either nylon or polyester fibers so that a sling made solely of high Young's modulus fibers would not be economically viable.

There is therefore a need for an improved sling providing adequate yield strength and wear resistance while still being economically attractive.

### SUMMARY OF THE INVENTION

The present invention therefore provides a textile sling that overcomes or mitigates one or more disadvantages of known textile slings, or at least provides a useful alternative.

The present invention combines the advantages of a low-cost sling with the improved performance from fibers having a higher Young's modulus. With a simple manufacturing process, it is now possible to manufacture viable slings using, in the warp thread, a major weight content of yarns made from fibers having a lower Young's modulus and a minor content of yarns made from fibers having a higher Young's modulus.

In accordance with an embodiment of the present invention, there is provided a textile sling having a continuous weave pattern. The sling comprises, in the warp thread, a major weight content of a first type of yarn made of a first type of fibers and a minor weight content of a second type of yarn made of a second type of fibers. The second type of fibers has a higher Young's modulus than the first type of fibers. The second type of yarn has a longer free-length than the first type of yarn so that the second type of yarn does not rupture, under a tension load, before the first type of yarn does.

In accordance with another embodiment of the present invention, there is provided a method of manufacturing a textile sling. The method comprises threading in the warp thread a first type of yarn made of a first type of fibers with a second type of yarn made of a second type of fibers. The second type of fibers has a higher Young's modulus than the first type of fibers. The second type of yarn is threaded with less tension than the first type of yarn.

### BRIEF DESCRIPTION OF DRAWINGS

These and other features of the present invention will become more apparent from the following description in which reference is made to the appended drawings wherein:

FIG. 1 is a perspective view of an example of application of the sling in accordance with an embodiment of the present invention.

FIG. 2 is a perspective view of a sling in accordance with an embodiment the present invention.

FIG. 3 is a cross-sectional view of the sling of FIG. 2.

FIG. 4 is a cross-sectional view of a sling in accordance with another embodiment of the present invention.

FIG. 5 is graph of the deformation of yarns of a sling made of different types of fibers as a function of an applied tension load.

FIG. 6 is a schematic view of the manufacturing equipment used to manufacture the slings of FIG. 3 and FIG. 4.

FIG. 7 is a plan view of an example of application of the sling in accordance with another embodiment of the present invention.

### DETAILED DESCRIPTION OF THE INVENTION

The present invention will now be generally described with respect to a sling for hoisting loads, although the same invention could also be applied to other uses such as safety belts, for example. Different yarns made of different types of fibers, having different properties and different costs may be combined for the manufacturing of a textile sling. However, it is known that some combinations may lead to the rupture of some yarns when the sling is loaded in tension. This typically happens when a minor weight content of yarns made of fibers having a high Young's modulus (hereinafter called the High yarns) is combined with a major weight content of yarns made of fibers having a lower Young's modulus (hereinafter called the Low yarns). Because the few High yarns cannot elongate as much as the bulk of the Low yarns, the former takes up most of the load and ruptures. We will now proceed to explain how the present invention overcomes this situation.

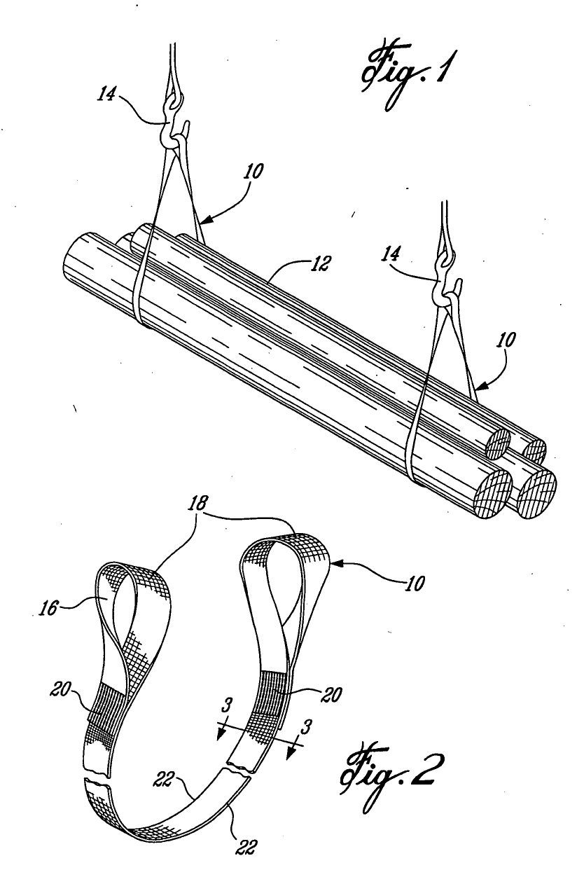

Referring first to FIG. 1, there is shown a sling 10 in its working environment. Here, the sling 10 is used for carrying a heavy load 12, such as logs. Each extremity of the sling 10 is inserted in a hoisting hook 14. Often, loads 12 are abrasive on the sling 10, especially on its edges. Therefore, to improve the life of the sling 10, it is important to reinforce either its surface or its edges so that they better withstand abrasion.

As best seen in FIG. 2, the sling 10 is a flat strap having a repeating, continuous pattern 16. A continuous pattern means that the sling 10 has no major discontinuity in its weave. A loop 18 is formed at each end of the sling 10 by folding back the ends of the sling 10 on itself and stitching them in place at stitch locations 20. Edges 22 run all along the body of the sling 10.

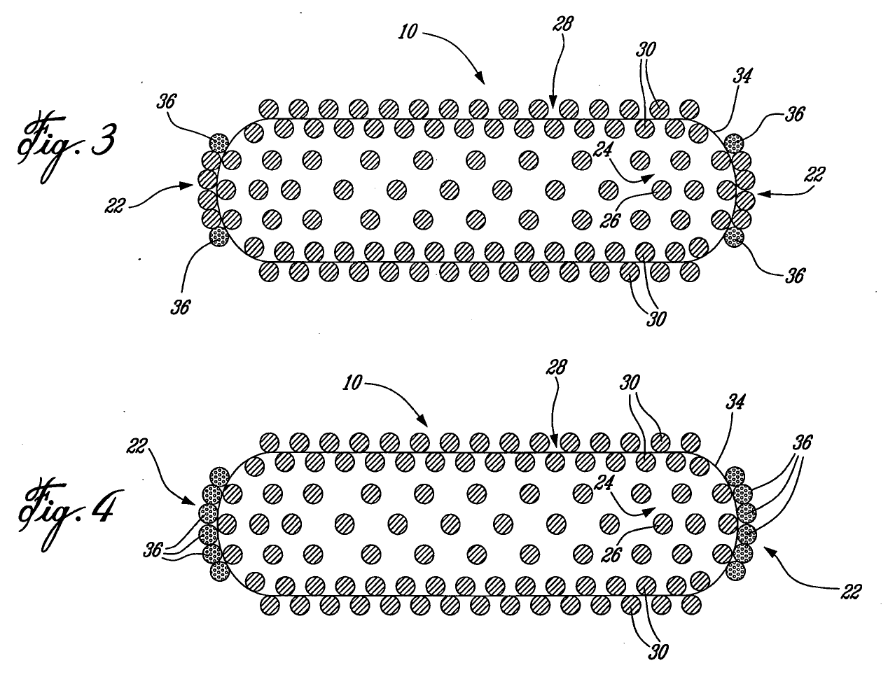

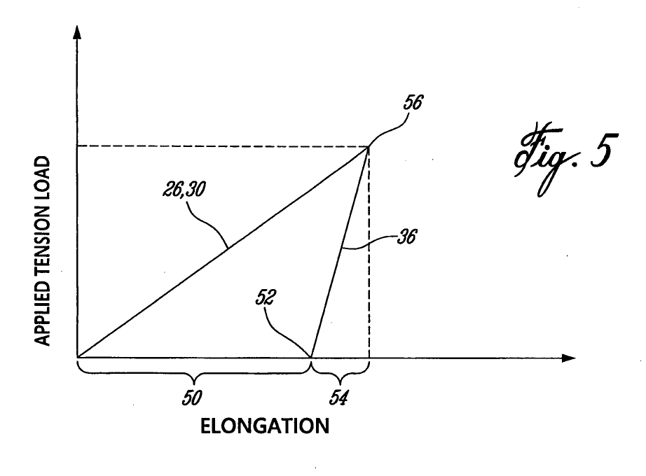

FIG. 3 shows a cross-section of the sling 10. The sling 10 is provided with a core 24 made up of warp yarns 26 formed of any suitable fibers and packed to form a rectangular cross-section having edges 22. The core 24 is surrounded by an outer ply 28 consisting of woven yarns 30. The outer ply 28 is formed with longitudinal woven yarns 30 and transverse or lateral weft yarns 34.

Reinforcing yarns may be used in the sling to provide enhanced characteristics. Such reinforcing yarns are made of a different type of fibers having characteristics differing from the characteristics of the fibers used in the bulk of the yarns making up the sling. Such reinforcing yarns may be used to replace some of the warp yarns 26 or some of the woven yarns 30. Often, these reinforcing yarns are High yarns. Because High yarns are usually more expensive than Low yarns, there is an incentive to keep the cost down by manufacturing a sling having a major weight content of Low yarns and a minor weight content of High yarns. For example, aramid fiber, which qualifies as a High yarn, has better wear resistance than any other High or Low yarns. Because of the cost of aramid fibers, the quantity of High yarns so made is kept to the minimum required. Referring again to the example of FIG. 3, the warp yarns 26 and the woven yarns 30 may be made of Low yarns made of polyester fibers while reinforcement yarns 36, which in this case are threaded along the edges 22 for protecting them against abrasion, may utilize more expensive High yarns made of aramid fibers. When using aramid fibers for its advantageous wear properties, it is important to thread the yarns made of such fibers so that they are at least partially exposed to an exterior surface of the sling 10, where wear occurs. Shown below is a comparative table of typical values of different types of fibers.

| | Young's modulus | Yield Strength |
|---|---|---|
| | (GPa) | (MPa) |
| Carbon fiber | 300 | 3430 |
| Aramid fiber | 124 | 3930 |
| Polyester fiber | 13.2 | 784 |
| Nylon fiber | 3.9 | 616 |

Reinforcement yarns 36 are woven with other woven yarns 30 and therefore run along the edges 22 in a continuous pattern. More or less reinforcement yarns 36 could be used to protect the edges 22 from wear and cut. For example, FIG. 4 shows that both edges 22 are completely made of reinforcement yarns 36.

Warp yarns 26, woven yarns 30 and reinforcement yarns 36 may be made of any suitable fibers such as polyester, nylon, aramid, carbon, etc. Different fibers have different properties. For example, aramid fibers have the best wear resistance of all fibers. This property alone would make it the first choice when it comes to manufacturing wear resistant slings. However, its cost is much higher than some other fibers, which renders an all-aramid fibers sling not economically viable. Hence, aramid fibers are used in scarce quantity when manufacturing slings.

Concurrently referring to FIGS. 3 and 4, there are shown two examples of sling construction according to the present invention. In these examples, the warp yarns 26 making up the core 24 are made of polyester fibers. Similarly, woven yarns 30 are made of polyester. For improved wear protection, the edges 22 include reinforcement yarns 36 made of aramid fibers. All yarns in the warp direction, that is warp yarns 26, woven yarns 30 and reinforcement yarns 36, have the potential of being load-bearing elements. However, because aramid fibers have a higher Young's modulus than does polyester fibers, the reinforcement yarns 36 do not elongate as much under load as the polyester-made warp and woven yarns, 26, 30. In order to prevent this discrepancy in elongation and prevent premature rupture of the reinforcement yarns 36, which otherwise, would be overloaded, the reinforcement yarns 36 are woven with a different tension than both the warp yarns 26 and the woven yarns 30. The tension used to weave the reinforcement yarns 36 is lower than the tension used to weave the other yarns, thereby allowing for additional extension of the reinforcement yarns 36 under load. This difference in tension results in a difference in the weave take-up of a yarn (the weave take-up is the difference between the free-length, that is the unwoven length, and the woven length of a yarn). For example, because it is woven with less tension, the weave take-up of the reinforcement yarns 36 may be 15% while the weave take-up of the woven yarns 30 may be 10% for the same threading pattern. In other words, the reinforcement yarns 36 are woven more loosely than the tightly woven warp yarns 26 and woven yarns 30 so that the free-length of the reinforcement yarns 36 is longer than the free-length of both the warp yarns 26 and the woven yarns 30. Hence, the reinforcement yarns 36 can compensate for the higher elongation of the other yarns 26, 30 under load by first taking up the loose in its weave and then elongating when resisting an applied tension load.

Different construction of slings may be envisioned. For example, it has been found that a sling made of 85% polyester, 9% nylon and 6% aramid fibers on the edges 22 provided good results. However, the cost was slightly on the high side. Another sling made of 89.5% polyester, 9% nylon and 1.5% aramid fibers still provided good results at a lower cost. This type of sling uses the nylon on the surface for wear resistance and aramid fibers on the edges, which are subjected to even more severe cut and wear. Different other combinations may be used. For example, nylon could be replaced by polyester if surface abrasion is minor.

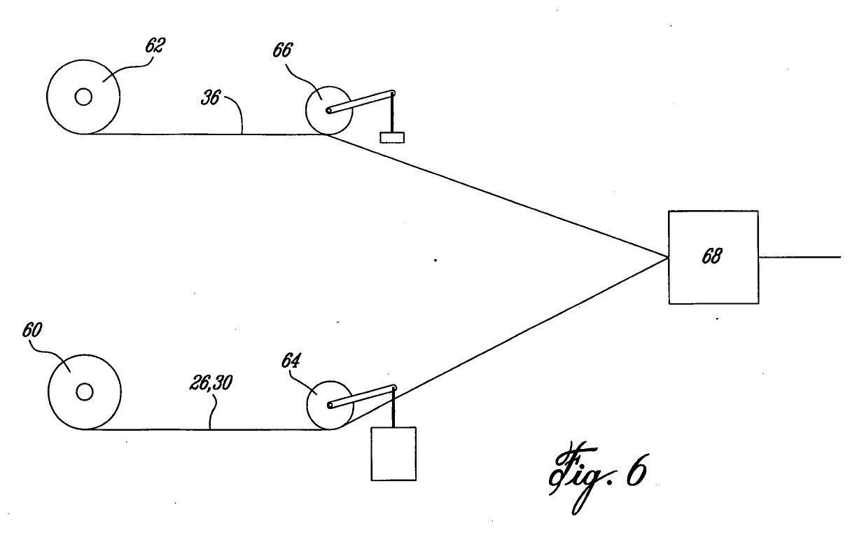

FIG. 5 shows an example of the elongation of each yarn type as a function of an applied load. During an initial sling elongation 50, it is possible to see that as the tension load increases, almost the entirety of the load is resisted by the warp and woven yarns 26, 30, here made of Low yarns. Because the reinforcement yarns 36, made of High yarns, were woven with less tension than both the warp yarns 26 and the woven yarns 30, the reinforcement yarns 36 barely support any load during this initial elongation 50, as they rearranges themselves by taking up their slack in the weave. At instant 52, the reinforcement yarns 36 are rearranged and start resisting the applied load. The elongation of the reinforcement yarns 36 corresponds to a secondary elongation 54. The sling ruptures at rupture point 56. The total elongation of the sling before rupture is the sum of the initial elongation 50 and the secondary elongation 54. During the secondary sling elongation 54, the reinforcement yarns 36 are loaded. During the manufacture of the sling 10, the tension on the reinforcement yarns 36 is adjusted so that they do not rupture before both the warp yarns 26 and the woven yarns 30.

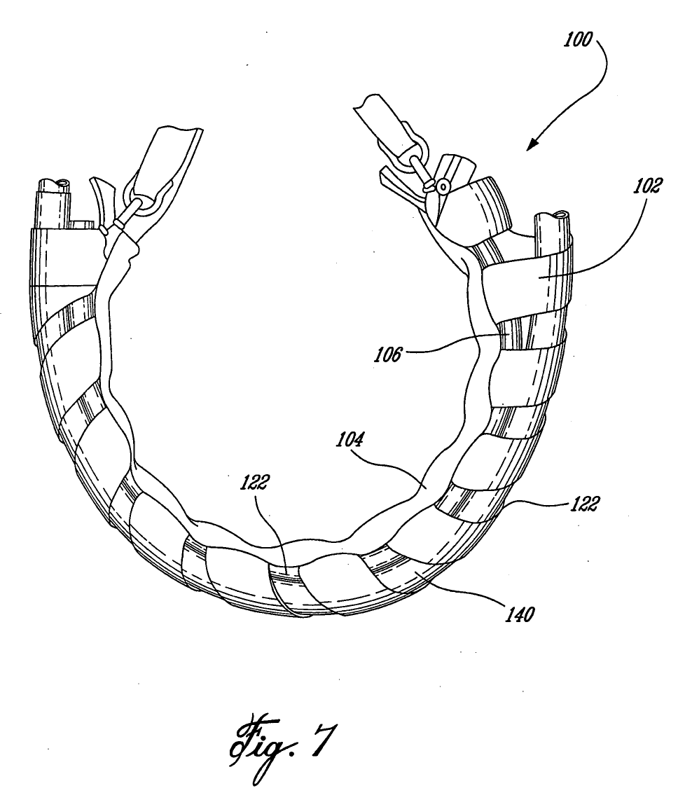

The manufacturing process will now be described with reference to FIG. 6. To manufacture slings made of High yarns and Low yarns, it is important to be able to adjust the tension on the yarns differently. Continuing with the previous example, the warp yarns 26 and woven yarns 30, made of Low yarns, are placed together on a first roller 60 while the reinforcement yarns 36, made of High yarns, are placed on a second roller 62. The warp yarns 26 and the woven yarns 30 are woven under tension using a first tension system 64 while the reinforcement yarns 36 are woven using their own independent second tension system 66. All yarns are then woven by the weaving loom 68 using a standard weaving method. To provide the intended result, the second tension system 66 is adjusted to provide less tension to the reinforcement yarns 36 than does the first tension system 64 to both the yarns 26 and woven yarns 30. The tension applied to the different yarns constituting a sling is adjusted depending on the Young's modulus of the specific types of fibers making the different yarns so that, under a tension load, the High yarns do not rupture before the Low yarns. If more than two different types of fibers are used in the warp thread of the sling 10, as many independent tension systems may be used. In addition, the tension may also be adjusted as a function of the percentage of each type of yarns used in the production of the sling 10. Because the tension is less on the reinforcement yarns 36, the weave take-up on these High yarns is more than the weave take-up on the other Low yarns. To manufacture a sling of a given length, it therefore takes longer High yarns than Low yarns.

The present invention is also adapted for use in specific applications requiring wear protection. For example, FIG. 7 depicts a protective spiral sleeve 100 made of slings 102, 104 and 106 woven according to one of the embodiments of the invention. Here, the slings 102, 104 and 106 use warp yarns made of polyester fibers, woven yarns made of nylon fibers and reinforcement yarns on the edges 122 made of High yarns such as aramid fibers. The spiral sleeve 100 is used to protect and group flexible hydraulic lines 140, especially used in heavy equipment for the forestry industry. Protective yarns protect the slings 102, 104 and 106 from abrasion caused by friction against tree branches.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description.

We claim:

1. A textile sling having a continuous weave pattern, said sling comprising in the warp thread:
a major weight content of a first type of yarn made of a first type of fibers; and
a minor weight content of a second type of yarn made of a second type of fibers;
wherein said second type of fibers has a higher Young's modulus than said first type of fibers, said second type of yarn having a longer free-length than said first type of yarn so that said second type of yarn does not rupture before said first type of yarn under a tension load.

2. A textile sling as defined in claim 1 wherein said second type of yarn is located at least partially on an exterior surface of said sling.

3. A textile sling as defined in claim 2 wherein said second type of yarn is a woven yarn.

4. A textile sling as defined in claim 3 wherein said second type of yarn is threaded proximate an edge of said sling.

5. A textile sling as defined in claim 4 wherein said first type of yarn bears a major part of a load when placed under tension.

6. A textile sling as defined in claim 5 wherein said second type of yarn is adapted to bear a load when placed under tension.

7. A textile sling as defined in claim 5 wherein said second type of fibers provides wear resistance to said sling.

8. A textile sling as defined in claim 7 wherein said second type of fibers is aramid fibers.

9. A textile sling as defined in claim 8 wherein said first type of fibers is polyester fibers.

10. A textile sling as defined in claim 9 further comprising, in the warp thread, a third type of yarns made of a third type of fibers placed on a surface of said sling.

11. A textile sling as defined in claim 10 wherein said third type of fibers is nylon fibers.

12. A textile sling as defined in claim 4 wherein said major weight content of said first type of yarn is more than 89%.

13. A textile sling as defined in claim 12 said major weight content of said first type of yarn is more than 97%.

14. A textile sling as defined in claim 13 wherein said minor content of said second type of yarn is less than 2%.

15. A textile sling as defined in claim 5 wherein said first type of yarn resists an applied tension load before said second type of yarn.

16. A textile sling having a continuous weave pattern, said sling comprising in the warp thread:
warp yarns made of polyester fibers;
woven yarns made of nylon fibers, said woven yarns being on a surface of said sling so as to protect said warp yarns from wear.

17. A textile sling as defined in claim 16 wherein said polyester fibers account for 95% of a weight of said sling and said nylon fibers account for 5% of said weight of said sling.

18. A method of manufacturing a textile sling comprising threading in the warp thread a first type of yarn made of a first type of fibers with a second type of yarn made of a second type of fibers having a higher Young's modulus than said first type of fibers, said second type of yarn being threaded with less tension than said first type of yarn.

19. A method as defined in claim 18 wherein a weight content of said first type of yarn in the warp thread is larger than a weight content of said second types of yarn.

20. A method as defined in claim 19 further comprising threading said second type of yarn proximate an edge of said sling.

21. A method as defined in claim 20 wherein said first type of fibers is polyester and said second type of fibers is aramid fibers.

22. A method as defined in claim 20 further comprising threading a third type of yarn made of a third type of fibers at a surface of said sling.

23. A method as defined in claim 22 wherein a weight content of said first type of yarn in the warp thread is larger than a weight content of said second and said third types of yarns combined.
